(19) United States
(12) Patent Application Publication
(10) Pub. No.: US 2005/0036644 A1
(43) Pub. Date: Feb. 17, 2005

(54) ADAPTER FOR CONNECTING A MOBILE PHONE STEREOEARPHONE-MICROPHONE SET TO A STEREO SYSTEM

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,688

(22) Filed: Aug. 11, 2003

(51) Int. Cl. H04R 25/00

(52) U.S. Cl. 381/384; 381/370

(57) ABSTRACT

An adapter for connector a mobile phone stereo earphone-microphone set to a stereo audio system is provided such that the stereo earphone-microphone set of a mobile phone can also be used on another stereo audio system via the adapter. The stereo audio system includes the multi-media device in a computer or a portable music system. Through the adapter, the range of application of an existing mobile phone stereo earphone-microphone is extended.

### BACKGROUND OF INVENTION

1. Field of the Invention

The present invention relates to an adapter. More particularly, the present invention relates to an adapter for connecting a mobile phone stereo earphone-microphone set to a stereo system.

2. Description of the Related Art

With great advance in wireless and semiconductor technologies, mobile phones are increasingly light and functionally powerful. Nowadays, mobile phone has become an indispensable tool for communicating with other people in our everyday life. In the past, most hands-free earphone sets (mobile phone earphone-microphone sets) are primarily used as a means of communication only. However, to expand the marketing opportunity, many manufacturers actively incorporates additional functions into each mobile phone. In other words, a mobile phone is no longer used solely as a means of communication.

Recently, manufacturers have successfully incorporated FM radio, MP3 and video-audio player into a mobile phone. To match these advanced products, the mono-channel hands-free earphone has also been changed to a stereo earphone with separate right and left channels. Hence, a user may choose to listen to the FM radio, the MP3 or the video-audio player between conversations.

Obviously, a mobile phone incorporating music program functions is more expensive than an ordinary one. Furthermore, the hands-free earphone set is also more expensive because the stereo headphone must have very high sound quality to meet the demand of the user.

However, the high-quality stereo earphone-microphone set can only hook up to the mobile phone. The mobile phone earphone-microphone set is not designed to connect directly with another stereo hi-fi system (for example, mobile phones, bedside audio systems, mobile audio systems including broadcast radios, CDs, MP3, MD) or the multimedia device (including the socket of a sound card) of a personal computer. At present, not even an adapter for connecting the mobile phone stereo earphone-microphone to a stereo system is out in the market yet.

To the user in possession of a mobile phone with musical functions, restricting the application of the free stereo earphone-microphone set solely to the mobile phone is a waste. In particular, it seems to be a big waste of resource if the stereo earphone-microphone set is not designed for plugging into the multi-media device of a personal electronic device or other stereo systems. Furthermore, if a user purchases another earphone-microphone set for plugging into the multi-media device of a personal computer or another stereo systems, the user has to carry two earphone-microphone sets altogether.

### SUMMARY OF INVENTION

Accordingly, one object of the present invention is to provide an adapter capable of connecting the mobile phone earphone-microphone set of a mobile phone to another stereo system including the multi-media device of a computer or another stereo audio device.

To achieve these and other advantages and in accordance with the purpose of the invention, as embodied and broadly described herein, the invention provides an adapter for connecting a mobile phone earphone-microphone set to a stereo system. The stereo system has an earphone socket and a microphone socket. The mobile phone earphone-microphone set comprises a left channel earplug, a right channel earplug, a microphone and a first connector. The first connector is a four electrode terminal with a first electrode, a second electrode, a third electrode and a fourth electrode. One terminal of the microphone is coupled to the first electrode of the first connector and a second terminal of the microphone is coupled to the fourth electrode of the first connector. One terminal of the left channel earplug is coupled to the second electrode of the first connector and a second terminal of the left channel earplug is coupled to the fourth electrode of the first connector. One terminal of the right channel earplug is coupled to the third electrode of the first connector and a second terminal of the right channel earplug is coupled to the fourth electrode of the first connector.

The adapter of the mobile phone earphone-microphone set comprises a second connector, a third connector and a socket. The second connector is a two electrode terminal with a first electrode and a second electrode for connecting to the microphone socket of the stereo system. The third connector is a three electrode terminal with a first electrode, a second electrode and a third electrode for connecting to the earphone socket of the stereo system. The socket has a first contact terminal, a second contact terminal, a third contact terminal and a fourth contact terminal. The first contact terminal is coupled to the first electrode of the second connector, the second contact terminal is coupled to the first electrode of the third connector, the third contact terminal is coupled to the second electrode of the third connector and the fourth contact terminal is coupled to both the second electrode of the second connector and the third electrode of the third connector. The socket is used for connecting with the first connector. When the first connector is plugged into the socket, the first contact terminal, the second contact terminal, the third contact terminal and the fourth contact terminal of the socket are in contact with the first electrode, the second electrode, the third electrode and the fourth electrode of the first connector respectively.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a conventional mobile phone earphone-microphone set.

FIG. 2 is a diagram showing the electrical connections of the mobile phone earphone-microphone set shown in FIG. 1.

FIG. 3 is a perspective view an adapter for a mobile phone earphone-microphone set according to one preferred embodiment of this invention.

FIG. 4 is a diagram showing the electrical connections of the adapter showing in FIG. 3.

FIG. 5 is a perspective view showing a conventional mobile phone earphone-microphone set connected to a stereo audio device using the adapter according to this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

After careful investigation on the mobile phone stereo earphone-microphone sets currently in the market, it is found that most earphone-microphone sets use just one connector (for example, a connection head or a connection port) for connecting with the mobile phone. Hence, the connector normally has four electrodes for connecting to the ground, the microphone, the left channel earplug and the right channel earplug.

In general, the multi-media device of a computer or the stereo audio device has separate earphone socket and microphone socket. On the other hand, most earplug audio system has an earplug socket but no microphone socket. In other words, an earphone-microphone set for most computer multi-media device and stereo audio device must have two head connectors, one for plugging into the microphone socket and another for plugging into the earplug socket. The former is a head connector having two electrode terminals for connecting the ground and the microphone and the latter is a head connector having three electrode terminals for connecting to the ground and the left and right channel earphone. The earphone head connector for an earplug audio system also has three electrode terminals for connecting to the ground and the left and right channel earphone. When the earphone-microphone set is used for linking up with an earplug audio system (having one earphone socket but without any microphone socket), only the earphone head connector remains functional. The microphone head connector is a dummy.

The number of head connectors and electrodes in the mobile phone stereo earphone-microphone set is different from the number of head connectors and electrodes required by the computer multi-media device, the stereo audio device or most earplug audio system. Hence, direct insertion of the head connector of the mobile phone stereo earphone-microphone set into the computer multi-media device, the stereo audio device or the earplug audio system is impossible.

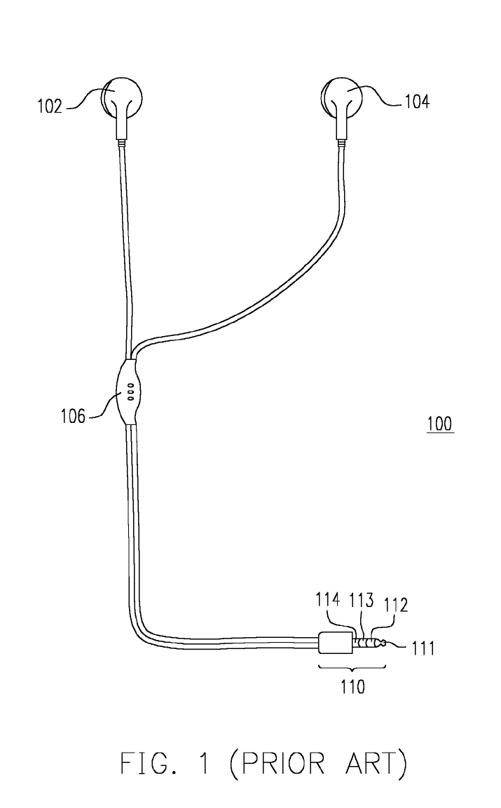

FIG. 1 is a perspective view of a conventional mobile phone earphone-microphone set. A mobile phone ear-phone-microphone headset 100 has a first connector 110 (a first head connector) having a diameter around 2.5 mm for connecting to a mobile phone (not shown). Aside from having a microphone 106, the earphone-microphone headset 100 also includes a left channel earplug 102 and a right channel earplug 104 for providing stereo sound. Therefore, the first connector 110 has four electrodes, including a first electrode 111, a second electrode 112, a third electrode 113 and a fourth electrode 114. For example, the first connector 110 is a four-electrode head connector or a four-electrode connection port. The fourth electrode 114 serves as a ground connection. The electrodes 111, 112 and 113 are connected to the microphone 106, the left channel earplug 102 and the right channel earplug 104 respectively.

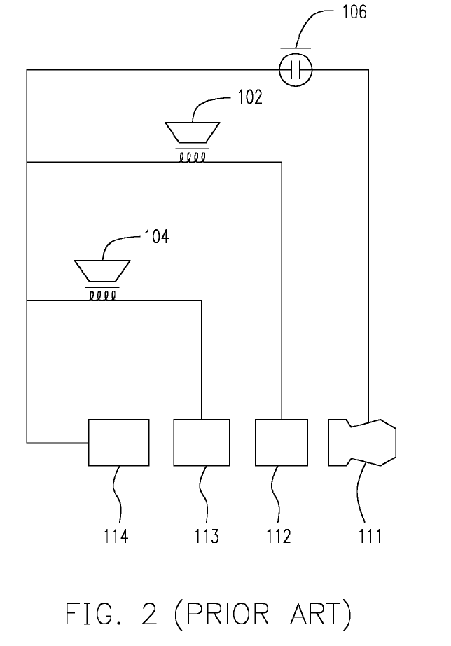

FIG. 2 is a diagram showing the electrical connections of the mobile phone earphone-microphone set shown in FIG. 1. Using a head connector as an example, the first connector 110 (the first head connector) has four electrodes including a first electrode 111, a second electrode 112, a third electrode 113 and a fourth electrode 114. A first terminal of the microphone 106 is coupled to the first electrode 111 of the head connector 110 and a second terminal of the microphone 106 is coupled to the fourth terminal 114 of the head connector 110. A first terminal and a second terminal of the left channel earplug 102 are coupled to the second electrode 112 and the fourth electrode 114 of the head connector 110 respectively. Similarly, a first terminal and a second terminal of the right channel earplug 104 are coupled to the third electrode 113 and the fourth electrode 114 of the head connector 110 respectively. The fourth electrode 114 is connected to a ground.

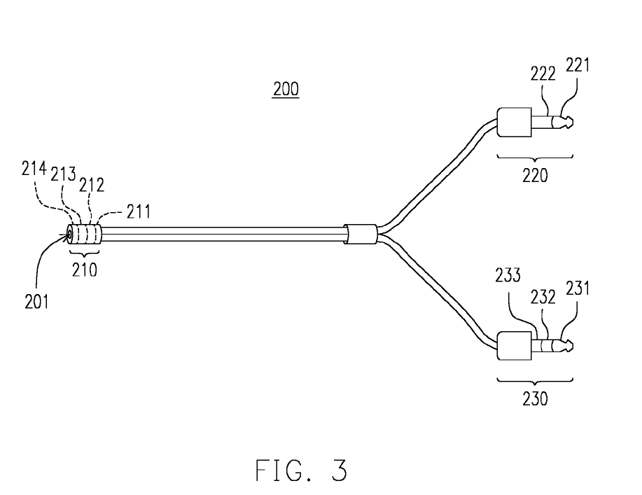

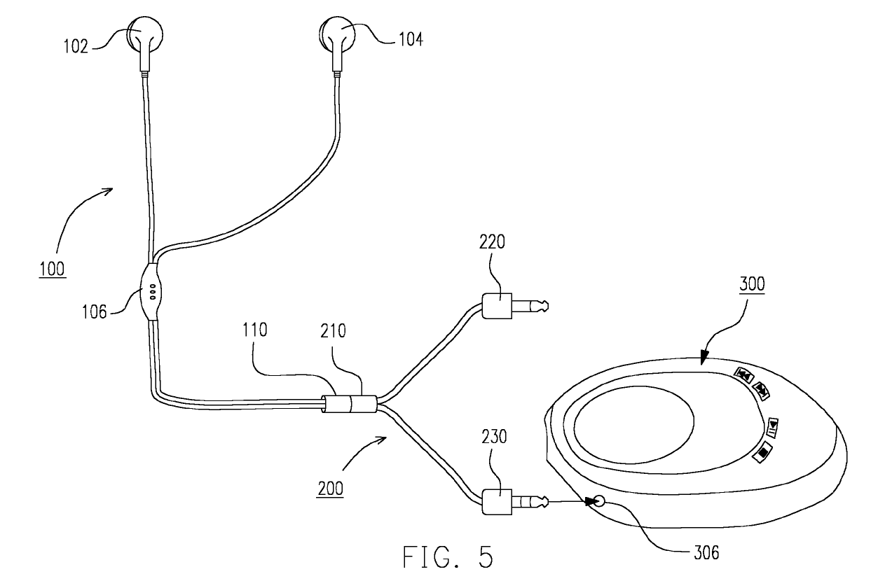

FIG. 3 is a perspective view an adapter for a mobile phone earphone-microphone set according to one preferred embodiment of this invention. An adapter 200 for connecting a mobile phone earphone-microphone set 100 to a stereo audio system 300 (refer to FIG. 5) is provided. The adapter 200 comprises a second connector 210, a microphone head connector 220 (a second head connector) and an earphone head connector 230 (a third head connector). The microphone head connector 220 and the earphone head connector 230 has a diameter around 3.5 mm, for example. The microphone head connector 220 has two electrode terminals including a first electrode 221 and a second electrode 222 for connecting to a microphone socket (not shown) in the stereo audio system 300. The earphone head connector 230 has three electrode terminals including a first electrode 231, a second electrode 232 and a third electrode 233 for connecting to an earplug socket 302 (refer to FIG. 5).

The second connector 210 is used for connecting with the first connector 110. For example, the second connector 210 can be shaped into a socket having a hole 201 for receiving the first connector 110 (the first head connector). The socket hole 201 has a diameter of around 2.5 mm, for example. The second connector (socket) 210 has four contact terminals for connecting with the four electrode contacts inside the head connector 110. Hence, through the socket 210, the left channel earplug 102, the right channel earplug 104 and the microphone 106 are coupled to another stereo audio system 300 (as shown in FIG. 5). The socket 210 has a first contact terminal 211, a second contact terminal 212, a third contact terminal 213 and a fourth contact terminal 214.

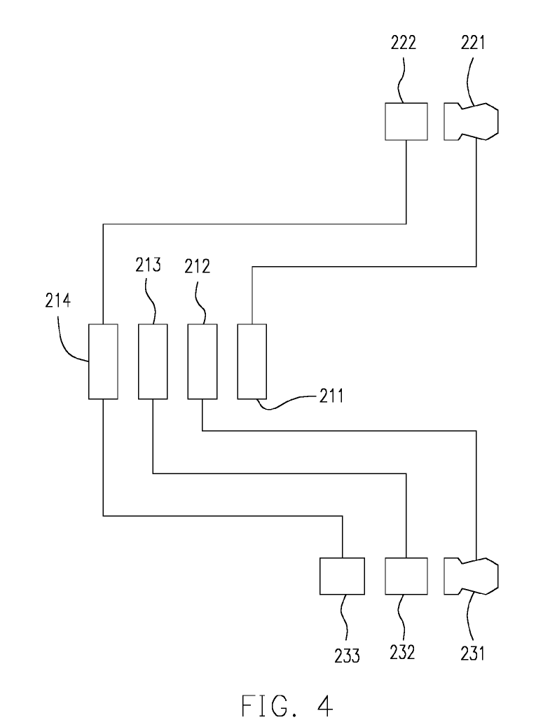

FIG. 4 is a diagram showing the electrical connections of the adapter showing in FIG. 3. A first contact terminal 211 is coupled to the first electrode 221 of the microphone head connector (the second head connector) 220. A second contact terminal 212 is coupled to the first electrode 231 of the earplug head connector (the third head connector) 230. A fourth contact terminal 214 is coupled to both the second electrode 222 of the microphone head connector 220 and the third electrode 233 of the earplug head connector 230.

FIG. 5 is a perspective view showing a conventional mobile phone earphone-microphone set 100 connected to a stereo audio device (portable audio system) 300 using the adapter 200 of this invention. A first connector (a first head connector) 110 of the mobile phone earphone-microphone set is connected to the second connector (socket) 210 of the adapter 200. Thus, the first contact terminal 211, the second contact terminal 212, the third contact terminal 213 and the fourth contact terminal 214 of the second connector (socket) 210 are in contact with the first electrode 111, the second electrode 112, the third electrode 113 and the fourth electrode 114 of the first connector (the first head connector) 110 respectively. Thereafter, the earplug head connector (the third head connector) 230 is plugged into the earplug socket hole 302 of the stereo audio system 300.

Although a portable audio system is used as an example in FIG. 5, the stereo audio system 300 can be other types of devices. For example, the stereo audio system 300 can be the multi-media device of a computer or other stereo sound systems (for example, a bedside sound system, hand-carried or portable audio devices). To connect with the multi-media device (not shown) of a computer, the microphone head connector and the earplug head connector of the adapter 200 are plugged into the earplug socket and the microphone socket of the sound card. Obviously, the head connectors of the adapter 200 may plug into the microphone socket (not shown) and the earplug socket 302 of the stereo audio system 300 on demand if the stereo audio system 300 has both. For example, if listening to music is all that is required, only the earplug head connector is plugged into the earplug socket 302 of the stereo audio system 300. On the other hand, if musical recording is required, the microphone head connector is also plugged into the microphone socket. When the earplug head connector 230 alone is plugged into the earplug socket 302 as shown in FIG. 5, the microphone head connector 220 is a passive dummy.

In this invention, the adapter 200 serves as a means for providing a two electrode microphone head connector (a second head connector) 220 and a three electrode earplug head connector (a third head connector) 230 out of the four-electrode first connector (a first head connector) 110 of a mobile phone stereo earphone-microphone set. Hence, the mobile phone stereo earphone-microphone set can be used in some other stereo audio system.

According to one embodiment of this invention, the first connector of the adapter is a socket with a hole having a diameter of around 2.5 mm to match the specification of most head connectors of mobile phone earphone-microphone sets. However, the diameter of the socket hole need not be restricted to 2.5 mm. In addition, the diameter of the second and the third head connector of the adapter are preferably 3.5 mm to match the socket diameter of most multi-media devices and stereo audio system (having a diameter of 3.5 mm or 6 mm).

In summary, the adapter according to this invention provides a means of connecting a conventional mobile phone stereo earphone-microphone set to another stereo audio system besides the mobile phone. Since the same mobile phone earphone-microphone set can be used to link up with another stereo system, resources are saved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An adapter for connecting a mobile phone earphone-microphone set to a stereo audio system having an earplug socket and a microphone socket, wherein the mobile phone earphone-microphone set comprises a left channel earplug, a right channel earplug, a microphone and a first head connector, the first head connector is a four electrode terminal having a first electrode, a second electrode, a third electrode and a fourth electrode, a first terminal of the microphone is coupled to the first electrode of the first head connector and a second terminal of the microphone is coupled to the fourth electrode of the first head connector, a first terminal of the left channel earplug is coupled to the second electrode of the first head connector and a second terminal of the left channel earplug is coupled to the fourth electrode of the first head connector, a first terminal of the right channel earplug is coupled to the third electrode of the first head connector and a second terminal of the right channel earplug is coupled to the fourth electrode of the first head connector, the adapter comprising:
a second head connector, wherein the second head connector is a terminal with a first electrode and a second electrode for connecting to the microphone socket of the stereo audio system;
a third head connector, wherein the third head connector is a terminal with a first electrode, a second electrode and a third electrode for connecting to the earplug socket of the stereo audio system; and
a socket having a first contact terminal, a second contact terminal, a third contact terminal and a fourth contact terminal, wherein the first contact terminal is coupled to the first electrode of the second head connector, the second contact terminal is coupled to the first electrode of the third head connector, the third contact terminal is coupled to the second electrode of the third head connector, the fourth contact terminal is coupled to both the second electrode of the second head connector and the third electrode of the third head connector, and the socket is a means of connecting to the first head connector such that when the first head connector is plugged into the socket, the first contact terminal, the second contact terminal, the third contact terminal and the fourth contact terminal of the socket are in contact with the first electrode, the second electrode, the third electrode and the fourth electrode of the first head connector respectively.

2. The adapter of claim 1, wherein the stereo audio system comprises a computer multi-media system.

3. The adapter of claim 1, wherein the stereo audio system comprises a stereo hi-fi system.

4. The adapter of claim 3, wherein the stereo audio system comprises a portable music system.

5. The adapter of claim 1, wherein the socket has a socket hole for receiving the first head connector and the socket hole has a diameter about 2.5 mm.

6. The adapter of claim 1, wherein the second head connector and the third head connector have a diameter about 3.5 mm.

7. An adapter for connecting a mobile phone earphone-microphone set to a stereo audio system having an earplug socket, wherein the mobile phone earphone-microphone set comprises a left channel earplug, a right channel earplug, a microphone and a first head connector, the first head connector has a first electrode, a second electrode, a third electrode and a fourth electrode, a first and a second terminal of the microphone are coupled to the first and the fourth electrode of the first head connector, a first and a second terminal of the left channel earplug are coupled to the second and the fourth electrode of the first head connector, a first and a second terminal of the right channel earplug are coupled to the third and the fourth electrode of the first head connector, the adapter comprising:
a microphone head connector having a first electrode and a second electrode;
an earplug head connector having a first electrode, a second electrode and a third electrode for connecting to the earplug socket of the stereo audio system; and
a second connector having a first contact terminal, a second contact terminal, a third contact terminal and a fourth contact terminal, wherein the first contact terminal is coupled to the first electrode of the microphone head connector, the second contact terminal is coupled to the first electrode of the earplug head connector, the third contact terminal is coupled to the second electrode of the earplug head connector, the fourth contact terminal is coupled to both the second electrode of the microphone head connector and the third electrode of the earplug head connector, and the second head connector is a means of connecting to the first head connector such that when the first head connector is plugged into the socket, the first contact terminal, the second contact terminal, the third contact terminal and the fourth contact terminal of the second head connector are in contact with the first electrode, the second electrode, the third electrode and the fourth electrode of the first head connector respectively.

8. The adapter of claim 7, wherein the stereo audio system furthermore comprises a microphone socket for receiving the microphone head connector.

9. The adapter of claim 7, wherein the stereo audio system comprises a computer multi-media system.

10. The adapter of claim 7, wherein the stereo audio system comprises a stereo hi-fi system.

11. The adapter of claim 10, wherein the stereo audio system comprises a portable music system.
